(19) United States
(12) Patent Application Publication
(10) Pub. No.: US 2024/0329422 A1
(43) Pub. Date: Oct. 3, 2024

(54) VIBRATION-TYPE ACTUATOR AND OPTICAL DEVICE

(71) Applicant: CANON KABUSHIKI KAISHA, Tokyo (JP)

(72) Inventors: TAIGA NAGATA, Kanagawa (JP); HIROMITSU MORITA, Saitama (JP); AKIO ATSUTA, Kanagawa (JP)

(21) Appl. No.: 18/616,863

(22) Filed: Mar. 26, 2024

(30) Foreign Application Priority Data
Mar. 29, 2023 (JP) 2023-053891

(51) Int. Cl. G02B 27/64; G03B 13/36

(52) U.S. Cl. CPC G02B 27/646; G03B 13/36

(57) ABSTRACT

An actuator includes a vibrating body including an elastic body and a conversion element, a contact body configured to contact the vibrating body, and a device configured to control vibration of the vibrating body. The vibration generated in the vibrating body relatively moves the vibrating body and the contact body. The device performs control for compensation driving of a driving mechanism to be connected to the actuator and control for main driving of the actuator. In the compensation driving, at least one of decreasing a frequency, increasing a pulse width, increasing a phase difference, and decreasing the phase difference of a signal output from the device is performed within a period of the compensation driving, and control to transition to the main driving at end of the period of the compensation driving is performed.

### BACKGROUND

### Technical Field

The aspect of the embodiments relates to a vibration-type actuator that causes an ultrasonic vibrating body to generate vibrational waves to relatively move a moving body configured to contact the ultrasonic vibrating body with a frictional force, and an optical device.

### Description of the Related Art

Imaging devices, such as a camera device and a video device, in which a vibration-type actuator is used for auto focus (AF) driving and zoom driving, have been commercially available. There is a recent demand for a higher-speed and lower-noise driving to increase the quality of AF driving during moving image capturing. Under such circumstances, some imaging devices use a deceleration mechanism, such as a gear, serving as a driving force transmission mechanism to achieve a higher level of thrust. The deceleration mechanism is provided with a clearance, which is called “backlash”, to enable smooth driving of gears or the like. During an actual driving in a state where backlash is present, the backlash is taken up even when the transmission mechanism is operating and the transmission mechanism idles before the constituent elements of the transmission mechanism engage with each other, which makes it difficult to transmit a driving force. Accordingly, the amount of control increases during feedback control and over-speed driving occurs, so that gears swiftly collide with each other, which may lead to occurrence of noise. Thus, the related art uses a method of performing a compensation operation in which low-speed driving is performed at a constant drive frequency until the backlash is fully taken up, to thereby reduce driving sound.

For example, Japanese Patent Application Laid-Open No. 2006-333677 discusses an ultrasonic motor that outputs a first drive signal to take up backlash in a transmission mechanism for transmitting a driving force, and outputs a second drive signal, which is different from the first drive signal, after driving of a control target is detected. In this case, the first drive signal is driven at a specific fixed frequency.

Japanese Patent Application Laid-Open No. H05-137360 discusses a vibration wave motor that sets an interval until a variation in phase difference between monitor voltages of detection signals for detecting a vibration state of an actuator is detected as a compensation interval for compensating for backlash generated by a mechanical driving force transmission unit. In this case, the driving is performed at a specific fixed frequency in the backlash compensation interval.

However, if the transmission mechanism includes a multi-stage gear, backlash between gears is gradually taken up from a gear that is closest to the vibration-type actuator, so that a sliding load between the gears gradually increases in this process. A load is applied during a period in which the backlash between the first-stage vibration-type actuator and the gear is taken up, and then as the driving continues, the backlash between the second-stage and subsequent-stage vibration-type actuators and the gears is taken up. During this period, the load to be applied to the gears before the backlash in the first stage is taken up is larger than that after the backlash in the first stage is taken up.

FIG. 12 illustrates a control operation for backlash compensation driving of a vibration wave actuator of the related art. A horizontal axis represents time, and a vertical axis represents an expected drive speed and an expected drive frequency. During a period from time 0 to time T1, acceleration is continued until a backlash compensation speed is reached. During a period from time T1 to time T2, the driving is continuously performed by decreasing the drive frequency until backlash compensation at the backlash compensation speed is completed. In the vibration wave motor discussed in Japanese Patent Application Laid-Open No. H05-137360, the end of compensation is determined based on a variation in phase difference between vibration detection signals, or a variation in current. After the backlash compensation driving is finished, the acceleration is continued until a target speed is reached. After time T3 when the target speed is reached, a normal control operation is performed. However, in the case of compensating for backlash in the multi-stage gear, as the gears gradually engage with each other during the period from time T1 to time T2, the load increases and the backlash compensation speed decreases. Since the load increases and the backlash compensation speed decreases during the period from time T1 to time T2, the period of the driving with a backlash compensation amount increases. As the compensation speed decreases, a backlash compensation period extends to a length of about 0.5 to 1 second, which is recognizable by the user. Thus, it is difficult to perform a high-speed and low-noise driving.

### SUMMARY

According to an aspect of the embodiments, an actuator includes a vibrating body including an elastic body and a conversion element, a contact body configured to contact the vibrating body, and a device configured to control vibration of the vibrating body. The vibration generated in the vibrating body relatively moves the vibrating body and the contact body. The device performs control for compensation driving of a driving mechanism to be connected to the actuator and control for main driving of the actuator. In the compensation driving, at least one of decreasing a frequency, increasing a pulse width, increasing a phase difference, and decreasing the phase difference of a signal output from the device is performed within a period of the compensation driving, and control to transition to the main driving at end of the period of the compensation driving is performed.

Further features of the disclosure will become apparent from the following description of exemplary embodiments with reference to the attached drawings.

### BRIEF DESCRIPTION OF THE DRAWINGS

FIG. 1 is a diagram illustrating a relationship between time and an acceleration parameter and a relationship between time and a speed according to a first exemplary embodiment.

FIG. 2 is a diagram illustrating a relationship among a phase difference, a pulse width, a frequency, and a speed with respect to a control amount according to the first exemplary embodiment.

FIG. 3 is a flowchart illustrating an algorithm according to the first exemplary embodiment.

FIG. 4 illustrates examples of values of acceleration parameter increase rates.

FIG. 5 illustrates graphs illustrating a relationship between time and an acceleration parameter and a relationship between time and a speed according to a second exemplary embodiment.

FIG. 6 (consisting of FIGS. 6A and 6B) is a flowchart illustrating an algorithm according to the second exemplary embodiment.

FIG. 7 illustrates examples of values of acceleration parameters according to the second exemplary embodiment.

FIG. 8 is a schematic perspective view of a camera device incorporating a vibration-type actuator according to the present disclosure.

FIG. 9 is an exploded perspective view of the vibration-type actuator according to the present disclosure.

FIG. 10 is a perspective view of the assembled vibration-type actuator illustrated in FIG. 9.

FIG. 11 is a circuit diagram illustrating a configuration of a vibration-type actuator control circuit for a vibration-type actuator device.

FIG. 12 illustrates a relationship between time and a speed and a relationship between time and a frequency in actual backlash compensation driving in a vibration-type actuator device according to related art.

### DESCRIPTION OF THE EMBODIMENTS

The aspect of the embodiments is directed to providing a vibration-type actuator that includes a vibrating body including an elastic body and an electric-mechanical energy conversion element, a contact body configured to contact the vibrating body, and a control device configured to control vibration of the vibrating body. The vibration generated in the vibrating body relatively moves the vibrating body and the contact body.

In addition, the control device executes control of backlash compensation driving of a driving mechanism that is connected to the vibration-type actuator, and control of main driving of the vibration-type actuator. In the backlash compensation driving, at least one of decreasing a frequency, increasing a pulse width, increasing a phase difference, and decreasing the phase difference of an alternating current signal to be output from the control device is executed within a period of the backlash compensation driving. After that, control of transition to the main driving at end of the period of the backlash compensation driving is performed.

An interval from start of the backlash compensation driving to when a drive amount of the driving mechanism is detected by a detection unit is defined as a first interval. An interval from end of the first interval to when a target backlash compensation speed is reached is defined as a second interval. An interval from when the target backlash compensation speed is reached to when backlash compensation is completed is defined as a third interval. An interval from end of the third interval to when a target speed of the vibration-type actuator is reached is defined as a fourth interval. An interval from end of the fourth interval to when a deceleration start position is reached is defined as a fifth interval. An interval from end of the fifth interval to when a stop position is reached is defined as a six interval.

In this case, the control device performs the backlash compensation driving in the second interval and the third interval and performs the main driving in the fourth interval, the fifth interval, and the sixth interval.

Further, at least one of a decrease rate of the frequency, an increase rate of the pulse width, an increase rate of the phase difference, and a decrease rate of the phase difference is set to at least part of the second interval and the third interval. In at least a part of the second interval and the third interval, at least one of the frequency, the pulse width, and the phase difference is set in correspondence with the second interval and the third interval.

The decrease rate of the frequency, the increase rate of the pulse width, the increase rate of the phase difference, and the decrease rate of the phase difference set to at least part of the first interval, the second interval, and the third interval may be smaller than those set in the fourth interval.

Specifically, the backlash compensation driving may be executed during reverse driving of the vibration-type actuator.

In view of the foregoing, it is possible to provide an optical device including the above-described vibration-type actuator and an optical element that is driven by the vibration-type actuator.

Exemplary embodiments of the disclosure will be described in detail below with reference to the accompanying drawings.

A first exemplary embodiment of the disclosure will be described below. A vibration-type actuator has a configuration in which an alternating voltage (drive voltage) for generating vibrations in a plurality of modes of a vibrating body is applied to the vibrating body that has an electric-mechanical energy conversion element (piezoelectric element) attached to an elastic body, thus generating vibrations. A moving body (contact body) to be brought into pressure contact with the vibrating body is frictionally driven (the vibrating body and the contact body are relatively moved), so that a driving force is obtained.

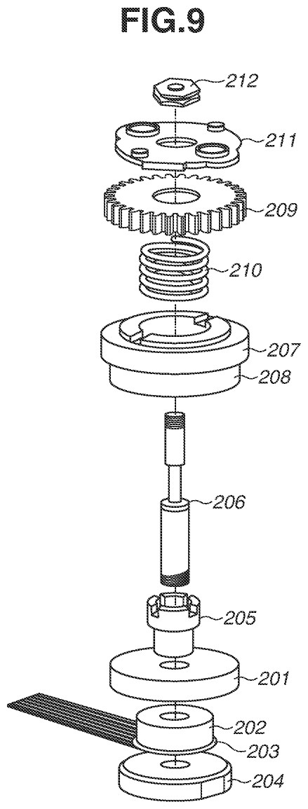

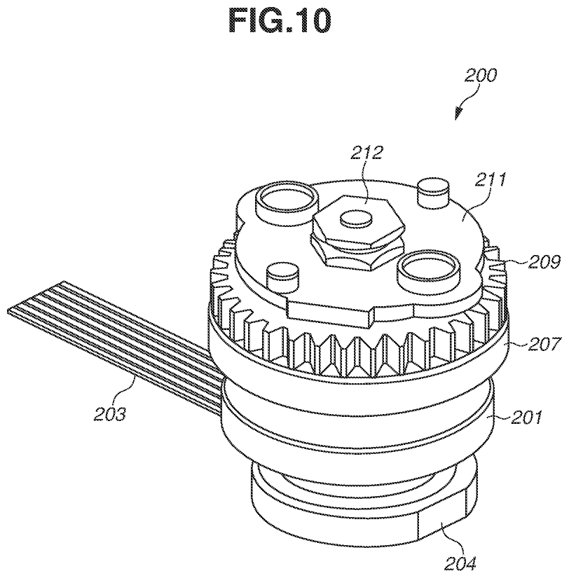

A configuration example of a vibration-type actuator will be described with reference to FIGS. 9 and 10. FIG. 9 is a perspective view (exploded perspective view) of a vibration-type actuator 200, which is an example of the vibration-type actuator, before assembly. FIG. 10 is a perspective view of the assembled vibration-type actuator 200 illustrated in FIG. 9.

The vibration-type actuator 200 illustrated in each of FIGS. 9 and 10 includes a plate (disk)-shaped first elastic body 201 made of a material with a small vibration attenuation loss, such as metal, a piezoelectric element 202 serving as an electric-mechanical energy conversion element, a flexible printed circuit 203 for applying an alternating current signal (alternating voltage) to the piezoelectric element 202 from a drive power supply, a lower nut 204 to be fitted to a screw portion formed at a lower end of a shaft 206, and a second elastic body 205.

The vibrating body includes at least the first elastic body 201, the piezoelectric element 202, the lower nut 204, and the second elastic body 205.

The shaft 206 is inserted into a through-hole that is formed at a central portion of each of the first elastic body 201, the piezoelectric element 202, the flexible printed circuit 203, and the second elastic body 205. A middle portion of the shaft 206 is provided with a step. This step is brought into contact with a step provided in an inner wall of the second elastic body 205. A tip end (lower end) of the shaft 206 has a screw. The lower nut 204 that is a fastening member is fixed and fastened to the screw, thus fixing the second elastic body 205, the first elastic body 201, the piezoelectric element 202, and the flexible printed circuit 203.

A contact spring 208 that is fixed to a moving body 207 (contact body) serving as a moving body (contact body) is brought into pressure contact with a surface of the first elastic body 201 that is not in contact with the piezoelectric element 202. The contact spring 208 has elasticity. The contact spring 208 is fixed to the moving body 207 (contact body) and is rotated integrally with the moving body 207. A gear 209 is an output unit that allows movement of the moving body 207 (contact body) in a rotational axis direction and is fitted to the moving body 207 (contact body) such that the gear 209 can rotate integrally with the moving body 207 (contact body).

A coil spring 210 is a pressurization unit that is disposed between a spring receiving portion of the moving body 207 (contact body) and the gear 209, and pressurizes the moving body 207 (contact body) such that the moving body 207 is pressed down toward the first elastic body 201. The gear 209 is rotatably supported by a fixing member 211 that is coupled to the shaft 206, and the position of the gear 209 in the axial direction is regulated by the fixing member 211. A tip end (upper end) of the shaft 206 that is not to be fitted to the lower nut 204 also has a screw. An upper nut 212 is fitted to the screw to thereby fix the shaft 206 to the fixing member 211. The fixing member 211 has screw holes. The fixing member 211 is fixed to a desired location with screws, so that the vibration-type actuator is attached to a desired location.

The above-described piezoelectric element 202 is provided with a driving electrode A (not illustrated) for generating a first bending vibration. When a predetermined alternating voltage is applied to the driving electrode A, an A-mode vibration is generated. A driving electrode B having a phase that is shifted by 90° from the first bending vibration in a rotational direction is provided. When a predetermined alternating voltage is applied to the driving electrode B, a B-mode vibration is generated. Alternating current signals that have different phases and have a resonance frequency close to that of the vibrating body are applied to the driving element A and the driving element B, thus generating vibrations that produce a force in the rotational direction in the elastic body 201.

At this time, an elliptic motion occurs. Here, this elliptic motion includes a motion in a vertical direction (axial direction) perpendicular to the rotational direction and a motion in the rotational direction (lateral direction) at each position in a drive direction on the elastic body 201. The contact spring 208 is brought into pressure contact with the surface of the first elastic body 201 on which the elliptic motion is excited, so that the contact spring 208 and the moving body 207 (contact body) is moved owing to the driving force of the elliptic motion.

The vibration-type actuator 200 having a configuration as described above may be used to smoothly move a lens in a zoom operation for a product to drive the lens. The vibration-type actuator for driving the lens may perform a constant-speed control to maintain a constant drive speed in a stable operation state.

In typical art, as a control device for such a vibration-type actuator, a unit for changing a drive frequency as a drive voltage frequency, a unit for changing a pulse width (drive voltage control parameter), and the like have been proposed.

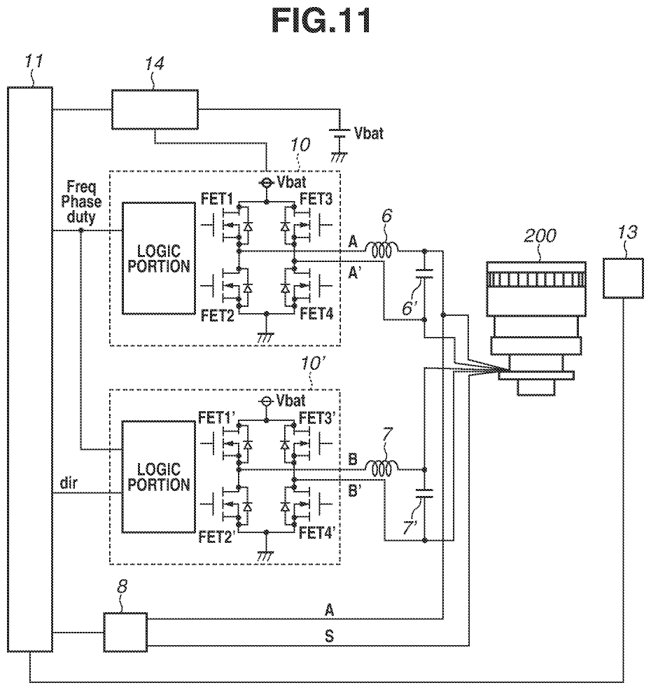

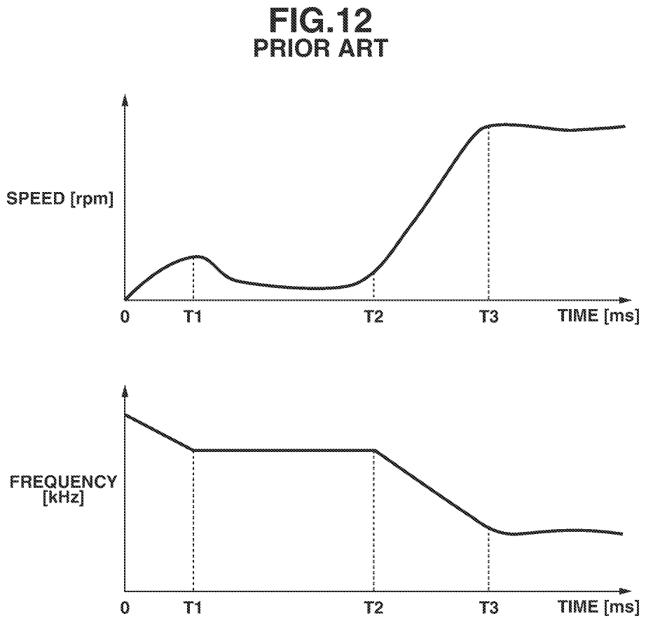

The drive frequency and the pulse width will be described with reference to FIG. 11.

FIG. 11 is a circuit diagram illustrating a drive circuit configuration of the above-described vibration-type actuator. The drive circuit includes the vibration-type actuator 200 serving as the vibration-type motor, and a control device (microcomputer unit) 11 for the vibration-type actuator that controls the vibration-type actuator. The control device 11 is, for example, a microcomputer. Hereinafter, the control device for the vibration-type actuator is also referred to as a microcomputer unit.

A section 10 represents an oscillator portion and a switching voltage generation unit that generate an alternating voltage (alternating current signal) for generating a first mode (A mode) vibration based on a command value from the microcomputer unit 11. A section 10′ represents an oscillator portion and a switching voltage generation unit that generate an alternating voltage (alternating-current signal) for generating a second mode (B mode) vibration based on a command value from the microcomputer unit 11.

The oscillator portion is configured to change a phase difference between the alternating voltage (alternating current signal) for generating the A-mode vibration and the alternating voltage (alternating current signal) for generating the B-mode vibration in a range from 0° to 360°.

The switching voltage generation unit 10 is a part of the unit for generating an alternating voltage (alternating current signal) for generating the A-mode vibration. Specifically, the switching voltage generation unit 10 is a switching circuit (unit) for switching a voltage of a power supply (Vbat) using switching elements FET 1 to FET 4. The voltage (switching voltage) generated by the switching voltage generation unit 10 is amplified due to a boosting effect using a combination of a coil 6 and a capacitor 6′, and is applied to an A-mode drive terminal of the vibration-type actuator.

The switching voltage generation unit 10′ is a part of the unit for generating an alternating voltage (alternating current signal) for generating the B-mode vibration. Specifically, the switching voltage generation unit 10′ is a switching circuit (unit) that switches the voltage of the power supply (Vbat) using switching elements FET 1′ to FET 4′. The voltage (switching voltage) generated by the switching voltage generation unit 10′ is amplified due to the boosting effect using a combination of a coil 7 and a capacitor 7′, and is applied to a B-mode drive terminal of the vibration-type actuator.

A power supply voltage detection circuit 14 detects the magnitude of the voltage of the power supply Vbat. The power supply Vbat is connected to each switching voltage generation unit, and produces a switching pulse (pulse signal) by switching the voltage of the power supply Vbat.

The term “drive frequency” used herein refers to a frequency at which the voltage of the power supply (Vbat) is switched by the switching circuit described above. A control for changing the drive speed by changing the drive frequency is hereinafter referred to as a frequency control.

The voltage of the power supply (Vbat) is switched by the switching circuit described above, and is then output as a switching pulse (pulse signal) from A, A′, B, and B′.

The term “pulse width” refers to a duration of time of the switching pulse (pulse signal). When the ratio of “ON” duration to “OFF” duration is 1:1, the duty ratio is 0.50 (50%), and when the ratio of “ON” duration to “OFF” duration is 1:3, the duty ratio is 0.25 (25%). A control for changing the drive speed by changing the pulse width is hereinafter referred to as a pulse width control.

A section 8 obtains a phase difference between an applied voltage and a detected voltage in the vibration-type actuator and monitors a resonance state.

A position detection unit 13 detects, for example, a rotational position of a rotary member including a photointerrupter and a slit plate. Based on a result obtained by the position detection unit 13, positional information and speed information about the rotary member are delivered to the microcomputer unit 11, and the microcomputer unit 11 controls the rotational position (driving position) and rotational speed (drive speed) of the vibration-type actuator based on the positional information and the speed information.

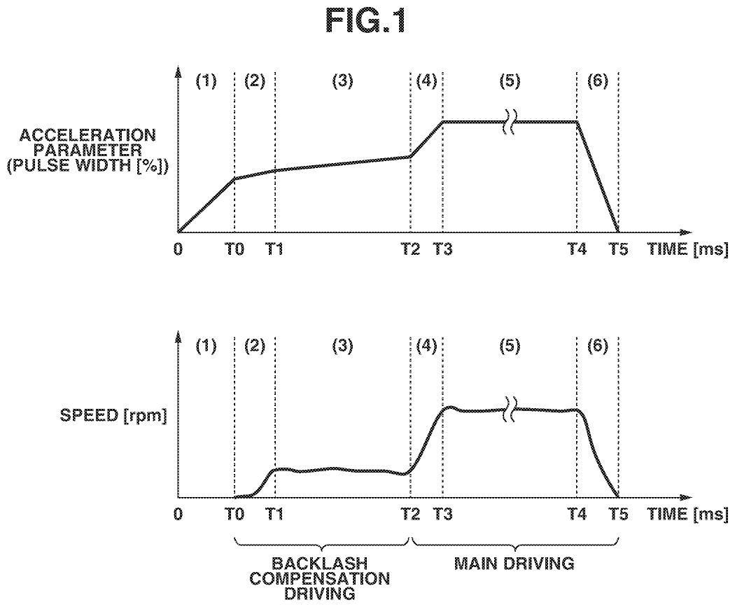

Exemplary embodiments of the disclosure will be described below with reference to FIGS. 1 to 4.

FIG. 1 illustrates graphs illustrating a temporal change of an acceleration parameter and a speed for backlash compensation driving in the vibration-type actuator according to the aspect of the embodiments. A pulse width, a phase difference, and a frequency that are used during acceleration are collectively referred to as an “acceleration parameter”. As a typical example of the acceleration parameter, the pulse width will be described below.

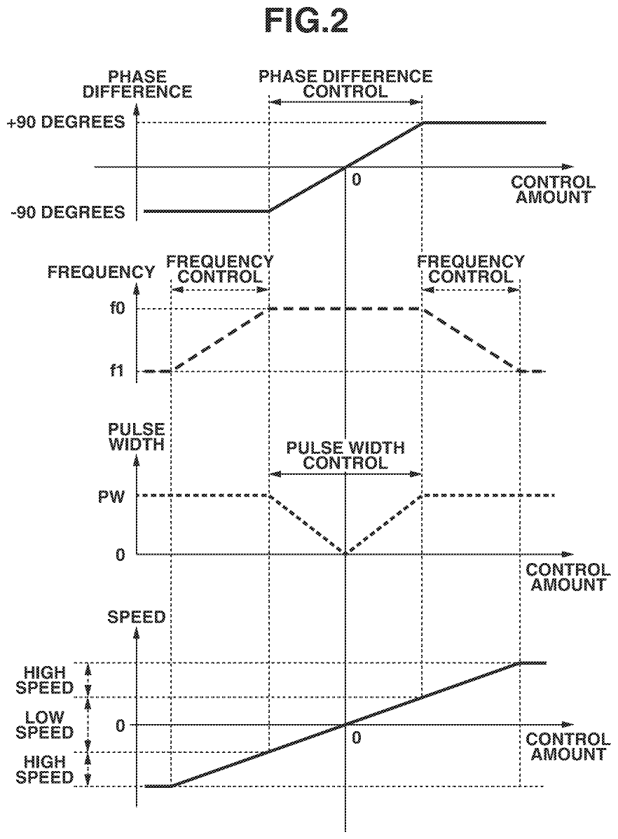

FIG. 2 illustrates a relationship among a phase difference, a pulse width, a frequency, and a speed with respect to a control amount. The phase difference, the pulse width, and the frequency are controlled such that the phase difference and the pulse width change (phase difference control, pulse width control) in an area where an absolute value of the control amount is small and the speed is low. The frequency, the phase difference, and the pulse width are controlled such that the frequency changes (frequency control) in an area where the absolute value of the control amount is large and the speed is high. A relationship between frequencies f0 and f1 illustrated in FIG. 2 is f0>f1. In other words, the driving using the phase difference and the pulse width and the control using the frequency are switched based on the control amount. As the acceleration parameter is changed according to the control amount, the speed of the vibration-type actuator changes. During the pulse width operation, a direction in which the pulse width increases matches an acceleration direction, and during the frequency operation, a direction in which the frequency decreases matches the acceleration direction. During the phase difference operation, one of the increasing direction or the decreasing direction matches the acceleration direction depending on the drive direction. In the present exemplary embodiment, a method of performing acceleration by the pulse width, as the acceleration parameter, being changed is described by way of example. Alternatively, any one of the pulse width, the frequency, and the phase difference may be changed, or a combination of some of the pulse width, the frequency, and the phase difference may be changed.

In the graphs illustrated FIG. 1, an interval from time 0 to time T0 is defined as a first interval (1), and the operation is started according to an acceleration parameter increase rate A. Time when a motion start is detected by an encoder corresponds to time T0. An interval from time T0 to time T1 is defined as a second interval (2). The acceleration is continued until the backlash compensation speed is reached at an acceleration parameter increase rate B. Time when the backlash compensation speed is reached corresponds to time T1. The backlash compensation speed is set as high as possible without causing driving sound, thus making it possible to reduce a compensation period. An interval from the speed time T1 to time T2 is defined as a third interval (3). The driving is continued until a compensation amount end position is reached at the backlash compensation speed. The driving corresponding to the backlash compensation amount is performed while the backlash compensation speed is maintained with a setting of an acceleration parameter increase rate C. During the driving at the compensation speed, backlash in a multi-stage gear is sequentially compensated and the load increases. However, also during this period, decrease in the compensation speed can be reduced and an increase in the compensation period can be prevented by increasing the acceleration parameter.

Time when the driving has been performed by the backlash compensation amount corresponds to time T2. An interval from time T2 to time T3 is defined as a fourth interval (4). The acceleration is continued until a target speed is reached with a setting of an acceleration parameter increase rate D. Time when the target speed is reached corresponds to time T3. An interval from time T3 to time T4 is defined as a fifth interval (5). In the fifth interval, feedback control is performed at the target speed. An interval from time T4 to time T5 is defined as a sixth interval (6). Deceleration from the target speed is performed, and then the operation is stopped. Time when deceleration is started corresponds to time T4, and time when the vibration-type actuator is stopped corresponds to time T5.

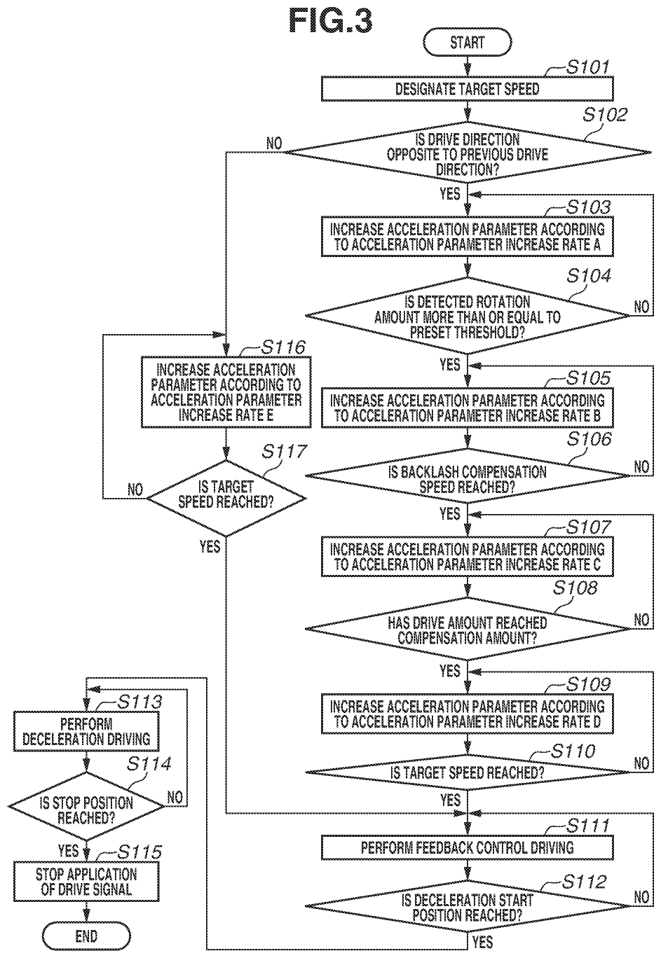

FIG. 3 is a flowchart illustrating a control method for the vibration-type actuator 200 according to the first exemplary embodiment. Each process illustrated in the flowchart of FIG. 3 is implemented such that the microcomputer unit executes a predetermined program stored in the microcomputer unit 11 to control the operation of each unit constituting the control.

This flowchart will be described below.

The backlash compensation speed and the compensation amount are set in advance.

In step S101, the target speed of the vibration-type actuator 200 is designated.

In step S102, the microcomputer unit 11 determines whether the drive direction matches the previous drive direction.

If the microcomputer unit 11 determines that the drive direction is opposite to the previous drive direction (YES in step S102), the processing proceeds to step S103.

If the drive direction is opposite to the previous drive direction, a maximum amount of backlash is present, which induces collision noises. For this reason, the backlash compensation driving according to the present disclosure is performed.

In step S103, the acceleration parameter is increased according to the acceleration parameter increase rate A.

In step S104, the microcomputer unit 11 determines whether a detected rotation amount is more than or equal to a preset threshold. If the microcomputer unit 11 determines that the detected rotation amount is less than a preset threshold (NO in step S104), the processing returns to step S103. If the microcomputer unit 11 determines that the detected rotation amount is more than or equal to the preset threshold (YES in step S104), the processing proceeds to step S105. The operations in steps S103 to S104 are performed in the first interval (1) illustrated in FIG. 1.

In step S105, the acceleration parameter is increased according to the acceleration parameter increase rate B. In step S106, the microcomputer unit 11 determines whether the speed has reached the backlash compensation speed. Here, the speed is a relative movement speed between a vibrating body 220 and a moving body 207, more specifically, a rotational speed of the moving body 207 relative to the vibrating body 220. Alternatively, the speed may be a movement speed or a rotational speed of a driving target connected to the gear 209. If the microcomputer unit 11 determines that the speed is less than the backlash compensation speed (NO in step S106), the processing returns to step S105. If the speed is more than or equal to the backlash compensation speed (YES in step S106), the processing proceeds to step S107. The operations in steps S105 to S106 are performed in the second interval (2) illustrated in FIG. 1.

In step S107, the acceleration parameter is increased according to an acceleration parameter increase rate C.

In step S108, the microcomputer unit 11 determines the drive amount from the motion start has reached the compensation amount. If the microcomputer unit 11 determines that the drive amount has not reached the compensation amount (NO in step S108), the processing returns to step S107. If the microcomputer unit 11 determines that the drive amount has reached the compensation amount (YES in step S108), the processing proceeds to step S109. The operations in steps S107 to S108 are performed in the third interval (3) illustrated in FIG. 1. The second interval and the third interval correspond to the backlash compensation driving.

In step S109, the acceleration parameter is increased according to an acceleration parameter increase rate D.

During the acceleration in steps S105, S107, and S109, if the speed exceeds the backlash compensation speed, the acceleration is stopped, and if the speed is lower than the backlash compensation speed, a process for resuming the acceleration may be added. Here, if a speed control is performed, a deceleration control may be performed when the speed exceeds the backlash compensation speed. The speed control is not suitable because driving sound is produced due to a rapid speed change at the point of switching from the acceleration to the deceleration. Thus, in steps S105, S107, and S109, the acceleration parameter is changed only in the increase direction. This prevents driving sound due to a rapid speed change. During the acceleration in steps S105, S107, and S109, a process for stopping the acceleration if the detected position exceeds an instructed position, and for resuming the acceleration if the detected position has not reached the instructed position may be added.

In step S110, the microcomputer unit 11 determines whether a target speed has been reached. If the target speed has not been reached (NO in step S110), the processing returns to step S109. If the microcomputer unit 11 determines that the target speed has been reached (YES in step S110), the processing proceeds to step S111. The operations in steps S109 and S110 are performed in the fourth interval (4) illustrated in FIG. 1.

In step S111, main driving is performed. In the main driving, position and speed feedback controls are performed.

In step S112, the microcomputer unit 11 determines whether a deceleration start position has been reached. If the microcomputer unit 11 determines that the deceleration start position has not been reached (NO in step S112), the processing returns to step S111 and a normal driving is continuously performed. If the deceleration start position has been reached (YES in step S112), the processing proceeds to step S113. The operations in steps S111 and S112 are performed in the fifth interval (5) illustrated in FIG. 1.

In step S113, deceleration driving is performed. The deceleration driving is a process for decreasing the acceleration parameter.

In step S114, the microcomputer unit 11 determines whether a stop position has been reached. If the microcomputer unit 11 determines that the stop position has not been reached (NO in step S114), the processing returns to step S113 and the deceleration driving is continuously performed. If the microcomputer unit 11 determines that the stop position has been reached (YES in step S114), the processing proceeds to step S115. The operations in steps S113 and S114 are performed in the sixth interval (6) illustrated in FIG. 1. The fourth interval, the fifth interval, the sixth interval correspond to the main driving.

In step S115, application of a drive signal is stopped, so that the vibration-type actuator 200 is stopped. Thus, the processing in this flowchart ends.

In step S102, if the microcomputer unit 11 determines that the drive direction matches the previous drive direction, the backlash between gears is taken up, so that noise due to the backlash does not occur. Accordingly, only the main driving is performed without performing the backlash compensation driving. If the microcomputer unit 11 determines that the drive direction matches the previous drive direction (NO in step S102), the processing proceeds to step S116.

In step S116, the acceleration parameter is increased according to an acceleration parameter increase rate E.

In step S117, the microcomputer unit 11 determines whether a target speed has been reached. If the microcomputer unit 11 determines that the target speed has not been reached (NO in step S117), the processing returns to step S116. If the microcomputer unit 11 determines that the target speed has been reached (YES in step S117), the processing proceeds to step S111. The operations in steps S111 to S115 are similar to those described above.

The acceleration parameter increase rates A to D will be described below. The acceleration parameter increase rate A, the acceleration parameter increase rate B, and the acceleration parameter increase rate C may be set to a value that does not cause gear collision sound. The acceleration parameter increase rate D is set to a value larger than the acceleration parameter increase rate A and the acceleration parameter increase rate B after the backlash compensation, thus reducing the period between T2 and T3 from the end of the backlash compensation to when the target speed is reached.

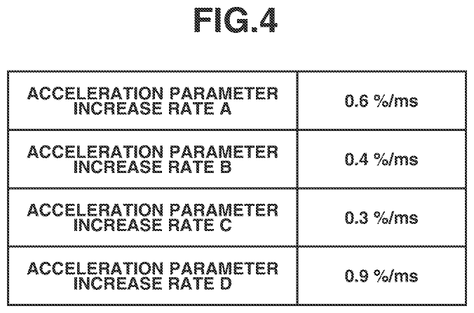

FIG. 4 illustrates examples of values of the acceleration parameter increase rates according to the first exemplary embodiment. For example, in a case where the pulse width is used as the acceleration parameter, pulse width increase rates are set as illustrated in FIG. 4.

According to the first exemplary embodiment, in the backlash compensation driving in steps S105 to S107, different acceleration parameter increase rates are set in the second interval and the third interval before and after the backlash compensation speed is reached. Alternatively, the third interval may be divided into three or more intervals and the acceleration parameter increase rate may be changed in each interval.

The acceleration parameter increase rates are individually set in the first interval and the second interval, so that acceleration smoother than acceleration in the main driving is performed and the compensation speed is reached while driving sound is reduced, which is one of beneficial effects of the first exemplary embodiment. In the third interval, the acceleration parameter is increased according to the acceleration parameter increase rate C, which enables the compensation driving while decrease in the backlash compensation speed is reduced even when the backlash is taken up and the load increases during the compensation. In the fourth interval, the acceleration is able to be started under no influence of backlash, which makes it possible to set the acceleration parameter increase rate D to a greater value and to reach the target speed in a shorter period of time. The above-described configuration makes it possible to perform a low-noise and high-speed driving, while preventing noise due to collision between gears within a sufficiently short compensation period of about 0.2 to 0.3 seconds.

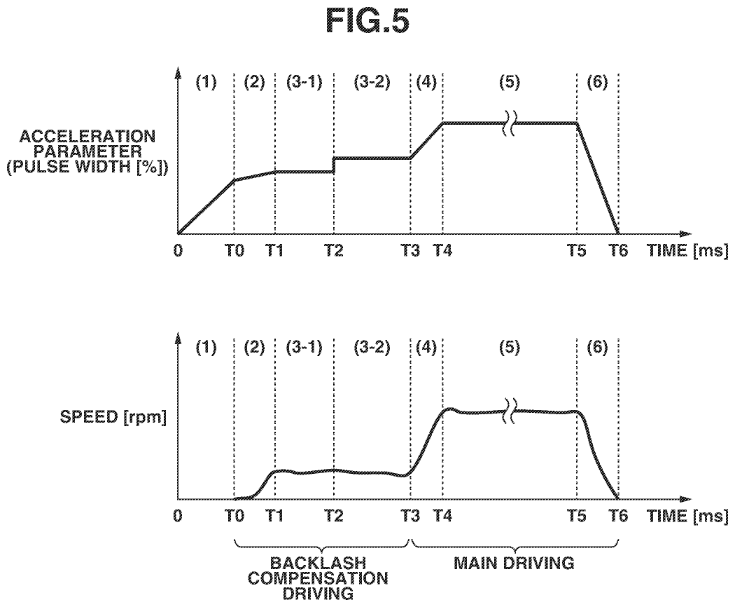

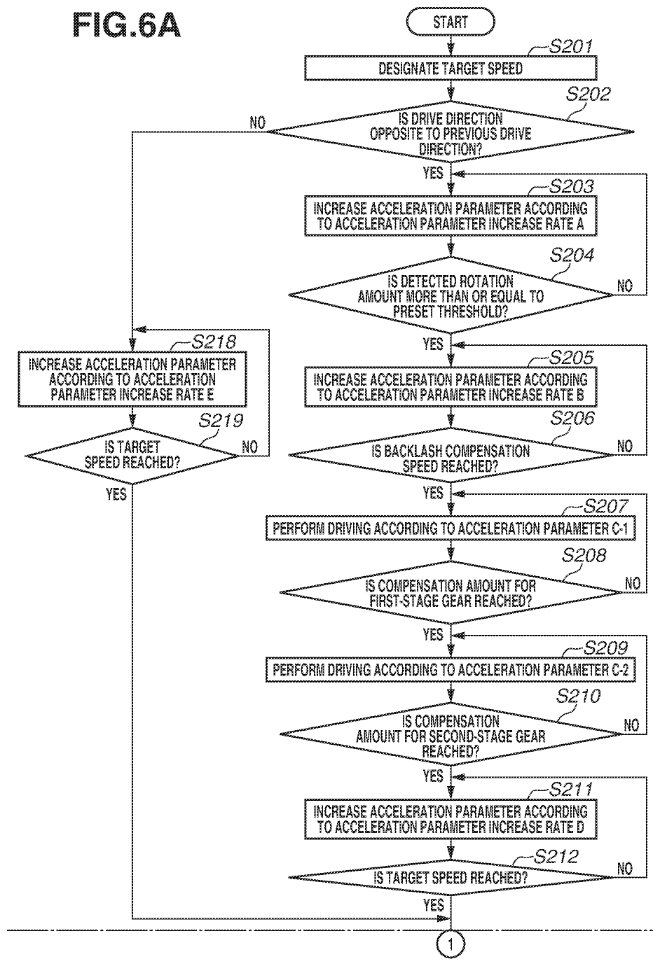

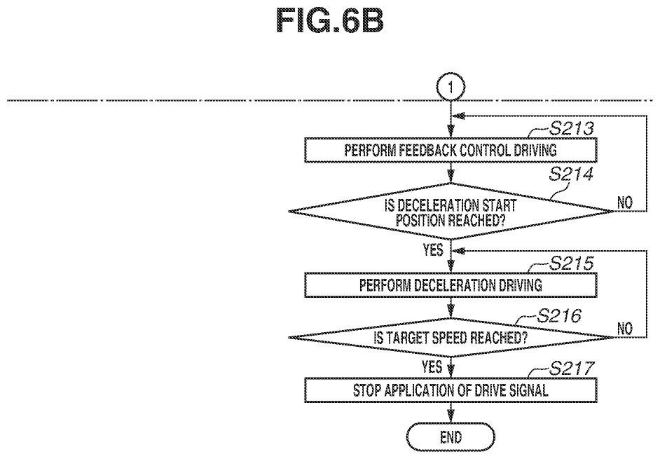

A second exemplary embodiment of the disclosure will now be described. In the first exemplary embodiment described above, the acceleration parameter increase rate is changed for each interval in the backlash compensation driving interval. In a second exemplary embodiment, the acceleration parameter is set for each interval. The second exemplary embodiment will be described below with reference to FIGS. 5 and 6. FIG. 5 illustrates a temporal change of the acceleration parameter and speed during backlash compensation driving in the vibration-type actuator according to the disclosure. The third interval illustrated in FIG. 1 is divided into intervals corresponding to the number of stages of the gear. A compensation amount to be set for the backlash up to when the backlash between gears is taken up can be calculated based on the number of teeth of the gear. Thus, a point when a driving corresponding to the compensation amount for each gear is performed corresponds to a timing of the division of interval. The microcomputer unit 11 stores, as a table, compensation amount switching positions and switching periods.

FIG. 5 illustrates a specific example for driving a mechanism with a two-stage gear connected. Activation is performed with a setting of the acceleration parameter increase rate A. Time when a motion start is detected by the encoder corresponds to time TO. An interval from time 0 to time T0 is defined as a first interval (1).

After time T0, the acceleration is continued until the backlash compensation speed is reached with a setting of the acceleration parameter increase rate B. Time when the backlash compensation speed is reached corresponds to time T1. An interval from time T0 to time T1 is defined as a second interval (2).

After time T1, the driving is performed with a fixed value of an acceleration parameter C-1. Time when the backlash in a first-stage gear is compensated corresponds to time T2. An interval from time T1 to time T2 is defined as a third-1 interval (3-1).

At time T2, the backlash in the first-stage gear has been taken up and the backlash in a second-stage gear stars to be taken up. After time T2, the load is increased by the amount corresponding to the first-stage gear, and thus the acceleration parameter is set to a greater acceleration parameter C-2. At time T2, switching from the acceleration parameter C-1 to the acceleration parameter C-2 may be gradually speeded up.

An interval from time T2 to time T3 is defined as a third-2 interval (3-2).

At time T3 when the backlash compensation amount for the second-stage gear is reached, the backlash compensation driving is finished, and then the operation transitions to main driving. The processing after time T3 is similar to that in the first exemplary embodiment.

While FIG. 5 illustrates a case where the two-stage gear is used, the acceleration parameters may be sequentially increased for a three or more-stage gear.

FIG. 6 (consisting of FIGS. 6A and 6B) is a flowchart illustrating a control method for the vibration-type actuator 200 according to the second exemplary embodiment. Each process in the flowchart of FIG. 6 is implemented such that the microcomputer unit 11 executes a predetermined program stored in the microcomputer unit 11 and controls the operation of each unit constituting a control circuit.

The flowchart will be described below. The backlash compensation speed and each backlash compensation amount are set in advance.

In step S201, a target speed for the vibration-type actuator 200 is designated.

In step S202, the microcomputer unit 11 determines whether the drive direction matches the previous drive direction.

If the microcomputer unit 11 determines that the drive direction is opposite to the previous drive direction (YES in step S202), the processing proceeds to step S203.

If the microcomputer unit 11 determines that the drive direction is opposite to the previous drive direction, backlash compensation driving is performed.

In step S203, the acceleration parameter is increased according to an acceleration parameter increase rate A.

In step S204, the microcomputer unit 11 determines whether a detected rotation amount is more than or equal to a preset threshold. If the microcomputer unit 11 determines that the detected rotation amount is less than the preset threshold (NO in step S204), the processing returns to step S203. If the microcomputer unit 11 determines that the detected rotation amount is more than or equal to the preset threshold (YES in step S204), the processing proceeds to step S205. The operations in steps S203 to S204 are performed in the first interval (1) illustrated in FIG. 5.

In step S205, the acceleration parameter is increased according to an acceleration parameter increase rate B.

In step S206, the microcomputer unit 11 determines whether the speed has reached the backlash compensation speed. Here, the speed is a relative movement speed between the vibrating body 220 and the moving body 207, more specifically, a rotational speed of the moving body 207 relative to the vibrating body 220. Alternatively, the speed may be a movement speed or a rotational speed of a driving target connected to the gear 209. If the microcomputer unit 11 determines that the speed is less than the backlash compensation speed (NO in step S206), the processing returns to step S205. If the microcomputer unit 11 determines that the speed is more than or equal to the backlash compensation speed (YES in step S206), the processing proceeds to step S207. The operations in steps S205 and S206 are performed in the second interval (2) illustrated in FIG. 5.

In step S207, the driving is performed with a setting of an acceleration parameter C-1.

In step S208, the microcomputer unit 11 determines whether the driving has been performed by the compensation amount for the first-stage gear. If the microcomputer unit 11 determines that the compensation amount for the first-stage gear has not been reached (NO in step S208), the processing returns to step S207. If the microcomputer unit 11 determines that the compensation amount for the first-stage gear has been reached (YES in step S208), the proceeds to step S209. The operations in steps S207 and S208 are performed in the third-1 interval (3-1) illustrated in FIG. 5.

In step S209, the driving is performed with a setting of an acceleration parameter C-2. At this time, the acceleration parameter C-2 is set to a value that is greater than the acceleration parameter C-1 by an amount in view of the amount corresponding to the load of the first-stage gear.

In step S210, the microcomputer unit 11 determines whether the driving has been performed by the compensation amount for the second-stage gear. If the microcomputer unit 11 determines that the compensation amount for the second-stage gear has not been reached (NO in step S210), the processing returns to step S209. If the compensation amount for the first-stage gear has not been reached (YES in step S210), the processing proceeds to step S209. The operations in steps S209 and S210 are performed in the third-2 interval (3-2) illustrated in FIG. 5.

After step S210, the main driving is performed in a manner similar to that in the first exemplary embodiment.

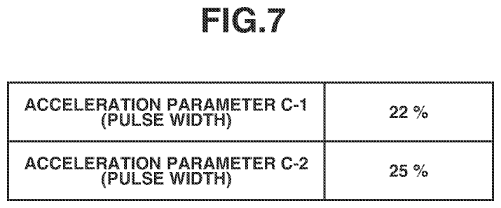

FIG. 7 illustrates examples of values of the acceleration parameters according to the second exemplary embodiment. For example, when the pulse width is used as the acceleration parameter, pulse widths are set as illustrated in FIG. 7.

Thus, the driving is performable by the compensation amount while a desired backlash compensation speed is maintained. This configuration makes it possible to perform a low-noise and high-speed driving, while preventing noise due to collision between gears within a sufficiently short compensation period of about 0.2 to 0.3 seconds.

As a beneficial effect of the second exemplary embodiment, the acceleration parameter increase rates are individually set in the first interval and the second interval, so that smoother acceleration than acceleration in the main driving is performed and the compensation speed is reached while driving sound is reduced. In the intervals third-1 (3-1) and third-2 (3-2), the driving is performed with the acceleration parameter corresponding to the load during backlash compensation for each gear of the multi-stage gear. Accordingly, the compensation driving is performable while decrease in the backlash compensation speed is reduced even when the backlash is taken up and the load increases during the compensation. In the fourth interval, the acceleration is able to be started under no influence of backlash, which makes it possible to set the acceleration parameter increase rate D to a greater value and to reach the target speed in a shorter period of time. The above-described configuration makes it possible to perform a low-noise and high-speed driving, while preventing production of noise due to collision between gears within a sufficiently short compensation period of about 0.2 to 0.3 seconds.

A third exemplary embodiment of the disclosure will be described below. A configuration example of an imaging device (optical device), such as a camera, will be described as an example of an a device including the vibration-type actuator 200 according to the first and second exemplary embodiments described above.

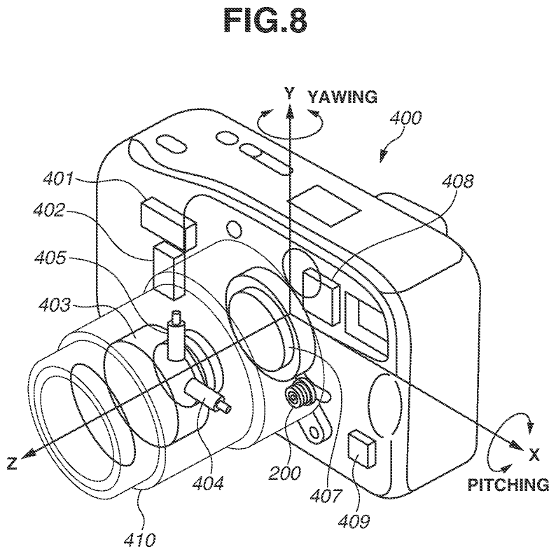

FIG. 8 is a schematic perspective view of a camera device incorporating the vibration-type actuator 200 according to the present disclosure, and also illustrates a perspective view of a part of the camera device.

As in the first and second exemplary embodiments, a hardware configuration of a driving device according to a third exemplary embodiment is similar to that of the driving device illustrated in FIG. 8. Thus, corresponding constituent elements are denoted by the same reference numerals, and descriptions thereof are omitted.

A lens barrel 410 is attached to a front surface of a digital camera 400. In the lens barrel 410, a plurality of lenses (not illustrated), including a focus lens 407, and a camera shake correction optical system 403 are disposed. Rotations of biaxial coreless motors 404 and 405 are transmitted to thereby allow the camera shake correction optical system 403 to vibrate in the vertical direction (Y-direction) and the horizontal direction (X-direction).

An image sensor 408 is disposed on a main body of the digital camera 400, and light that has passed through the lens barrel 410 is formed as an optical image on the image sensor 408. The image sensor 408 is a photoelectric conversion device such as a complementary metal-oxide semiconductor (CMOS) sensor or a charge-coupled device (CCD) sensor, and converts the optical image into an analog electric signal. The analog electric signal output from the image sensor 408 is converted into a digital signal by an analog-to-digital (A/D) converter (not illustrated). Then, predetermined image processing is performed on the digital signal by an image processing circuit (not illustrated), and the signal is stored as image data (video data) in a storage medium such as a semiconductor memory (not illustrated).

The main body of the digital camera 400 is provided with, as internal devices, a gyroscope sensor 401 that detects a camera shake amount (vibration) in the vertical direction (pitching), and a gyroscope sensor 402 that detects a camera shake amount (vibration) in the horizontal direction (yawing). The coreless motors 404 and 405 are driven in a direction opposite to the direction of the vibration detected by the gyroscope sensors 401 and 402, and an optical axis extending in a Z-direction of the camera shake correction optical system 403 is vibrated. As a result, the vibration of the optical axis due to a camera shake is cancelled out and the camera shake can be corrected, so that excellent images are captured.

The vibration-type actuator 200 is driven with the driving method described above in the first to third exemplary embodiments, and the focus lens 407 disposed in the lens barrel 410 is driven in the optical axis direction (Z-direction) via a gear train (not illustrated). However, the configuration of the vibration-type actuator 200 is not limited to this example. The vibration-type actuator 200 can be used for driving of any lens, such as driving for a zoom lens (not illustrated).

The driving device illustrated in FIG. 8 to drive the vibration-type actuator 200 with the driving method according to the first to third exemplary embodiments is incorporated in the main body of the digital camera 400 as a drive circuit 409.

The vibration-type actuator 200 for which the driving control according to the present disclosure is performed is mountable on the camera device as described above. This enables a driving for the vibration-type actuator 200 with stable driving characteristics even when an environment, such as a use temperature, varies. Consequently, it is possible to capture images and moving images with excellent quality.

The vibration-type actuator is used for focus lens driving and zoom lens driving for a camera, a video device, and the like. A function for capturing still images and moving images is incorporated in recent cameras, video devices, and the like. In one embodiment, a speed of focusing on an object in still image capturing may be increased, and thus the vibration-type actuator operates at high speed. In one embodiment, an object in moving image capturing may be tracked, and thus the vibration-type actuator may perform a low-noise and low-speed operation.

As described above, the lens of the vibration-type actuator may be moved as fast as possible and as silent as possible. In particular, driving sound produced during moving image capturing may be recorded on a captured moving image, which may provide a user with a feeling of strangeness.

Therefore, according to an aspect of the embodiments, it is possible to provide a vibration-type actuator capable of performing a lower-noise and higher-speed driving than those in the related art, so that the quality of moving images during auto focus (AF) driving is enhanced and a product range for various applications are broaden.

The aspect of the embodiments is suitably applicable to a vibration-type actuator and an optical device incorporating the vibration-type actuator.

According to an aspect the embodiments, it is possible to perform a low-noise and high-speed driving, while preventing noise due to collision between gears in compensation driving within a shorter compensation period in backlash compensation control for a driving mechanism to be connected to the vibration-type actuator.

### Other Embodiment

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-053891, filed Mar. 29, 2023, which is hereby incorporated by reference herein in its entirety.

What is claimed is:

1. An actuator comprising:
a vibrating body including an elastic body and a conversion element;
a contact body configured to contact the vibrating body; and
a device configured to control vibration of the vibrating body,
wherein the vibration generated in the vibrating body relatively moves the vibrating body and the contact body,
wherein the device performs control for compensation driving of a driving mechanism to be connected to the actuator and control for main driving of the actuator, and
wherein, in the compensation driving, at least one of decreasing a frequency, increasing a pulse width, increasing a phase difference, and decreasing the phase difference of a signal output from the device is performed within a period of the compensation driving, and control to transition to the main driving at end of the period of the compensation driving is performed.

2. The actuator according to claim 1, wherein the device performs the compensation driving in a second interval and a third interval, and performs the main driving in a fourth interval, a fifth interval, and a sixth interval, where an interval from start of the compensation driving to when a drive amount of the driving mechanism is detected by a detection unit is a first interval, an interval from end of the first interval to when a compensation speed is reached is the second interval, an interval from when the compensation speed is reached to when backlash compensation is completed is the third interval, an interval from end of the third interval to when a target speed of the actuator is reached is the fourth interval, an interval from end of the fourth interval to when a deceleration start position is reached is the fifth interval, and an interval from end of the fifth interval to when a stop position is reached is the six interval.

3. The actuator according to claim 2, wherein at least one of a decrease rate of the frequency, an increase rate of the pulse width, an increase rate of the phase difference, and a decrease rate of the phase difference is set to at least part of the second interval and the third interval.

4. The actuator according to claim 2, wherein, in at least a part of the second interval and the third interval, at least one of the frequency, the pulse width, and the phase difference is set in correspondence with the second interval and the third interval.

5. The actuator according to claim 3, wherein the decrease rate of the frequency, the increase rate of the pulse width, the increase rate of the phase difference, and the decrease rate of the phase difference set to at least part of the first interval, the second interval, and the third interval are smaller than those set to the fourth interval.

6. The actuator according to claim 2, wherein the compensation driving is performed during reverse driving of the actuator.

7. An optical device comprising:
the actuator according to claim 1; and
an element to be driven by the actuator.

8. The optical device according to claim 7, wherein the device performs the compensation driving in a second interval and a third interval, and performs the main driving in a fourth interval, a fifth interval, and a sixth interval, where an interval from start of the compensation driving to when a drive amount of the driving mechanism is detected by a detection unit is a first interval, an interval from end of the first interval to when a compensation speed is reached is the second interval, an interval from when the compensation speed is reached to when backlash compensation is completed is the third interval, an interval from end of the third interval to when a target speed of the actuator is reached is the fourth interval, an interval from end of the fourth interval to when a deceleration start position is reached is the fifth interval, and an interval from end of the fifth interval to when a stop position is reached is the six interval.

9. The optical device according to claim 8, wherein at least one of a decrease rate of the frequency, an increase rate of the pulse width, an increase rate of the phase difference, and a decrease rate of the phase difference is set to at least part of the second interval and the third interval.

10. The optical device according to claim 8, wherein, in at least a part of the second interval and the third interval, at least one of the frequency, the pulse width, and the phase difference is set in correspondence with the second interval and the third interval.

11. The optical device according to claim 9, wherein the decrease rate of the frequency, the increase rate of the pulse width, the increase rate of the phase difference, and the decrease rate of the phase difference set to at least part of the first interval, the second interval, and the third interval are smaller than those set to the fourth interval.

12. The optical according to claim 8, wherein the compensation driving is performed during reverse driving of the actuator.
